(19) United States
(12) Patent Application Publication
(10) Pub. No.: US 2026/0339088 A1
(43) Pub. Date: Oct. 29, 2026

(54) Enclosed Confocal Optical System

(71) Applicants: Sartorius BioAnalytical Instruments, Inc., Bohemia, NY (US); CrestOptics SpA, Rome (IT)

(72) Inventors: Paul Bierdz, Ann Arbor, MI (US); Nevine Holtz, Saline, MI (US); Kyle Schutte, Ann Arbor, MI (US); Raino Ceccarelli, Rome (IT); Fabio Nazzarri, Rome (IT); Claudio Sciascera, Rome (IT); Tomas Steponavicius, Turin (IT)

(21) Appl. No.: 19/187,156

(22) Filed: Apr. 23, 2025

(51) Int. Cl. G02B 21/00

(52) U.S. Cl. CPC G02B 21/0076; G02B 21/0032

(57) ABSTRACT

An optical instrument includes an enclosure that includes a window and a port configured to receive light. The instrument includes an objective configured to be aligned with the window, and an optical module positioned within the enclosure. The optical module includes a dichroic mirror and first optical element(s) configured to direct light from the port to the dichroic mirror. The optical module includes second optical element(s) configured to direct light from the dichroic mirror, through the window, and into the objective, and configured to direct light from the window to the dichroic mirror. The instrument includes a plate having openings patterned for confocal microscopy. The plate is configured to be inserted into or removed from an area between the dichroic mirror and the second optical element(s). The optical instrument includes an image sensor and third optical element(s) configured to direct light from the dichroic mirror to the image sensor.

### BACKGROUND

Researchers from many scientific fields value information that can be obtained from imaging live cells, for example, from detecting and quantifying the fluorescent emissions of cells over long periods of time under physiologically relevant environmental conditions. Some imaging systems include a small environmental chamber that is attached to the stage of a small microscope. However, such chambers have a limited capability to control the environment, which limits the types of experiments that can be conducted on cells. Accurately maintaining a target temperature and a target humidity for a large number of biological samples over a long period of time while the biological samples are accessible for inspection can be difficult.

### SUMMARY

A first example is an optical instrument comprising: an enclosure comprising: a window; and a port configured to receive a first light via an optical cable; an objective configured to be aligned with the window such that the first light exiting the enclosure through the window enters the objective and a second light from the objective enters the enclosure through the window; and an optical module positioned within the enclosure, the optical module comprising: a dichroic mirror; one or more first optical elements configured to direct the first light from the port to the dichroic mirror; one or more second optical elements configured to direct the first light from the dichroic mirror, through the window, and into the objective and configured to direct the second light from the window to the dichroic mirror; a plate having openings patterned for spinning disc confocal microscopy, wherein the plate is configured to be inserted into or removed from an area between the dichroic mirror and the one or more second optical elements; an image sensor; and one or more third optical elements configured to direct the second light from the dichroic mirror to the image sensor.

A second example is a method of operating an optical instrument, the method comprising: moving an optical module relative to a stage that supports a first biological sample and a second biological sample, thereby aligning the optical module with the first biological sample, wherein the optical module comprises a plate having openings patterned for spinning disc confocal microscopy; capturing one or more first images of the first biological sample using the optical module; moving the optical module relative to the stage, thereby aligning the optical module with the second biological sample; and capturing one or more second images of the second biological sample using the optical module.

A third example is a non-transitory computer readable medium storing instructions that, when executed by the optical instrument of the first example, cause the optical instrument to perform the method of the second example.

When the term “substantially” or “about” is used herein, it is meant that the recited characteristic, parameter, or value need not be achieved exactly, but that deviations or variations, including, for example, tolerances, measurement error, measurement accuracy limitations, and other factors known to those of skill in the art may occur in amounts that do not preclude the effect the characteristic was intended to provide. In some examples disclosed herein, “substantially” or “about” means within +/−0-5% of the recited value.

The entire contents of U.S. application Ser. No. xx/xxx,xxx, filed on xxxx, denoted as attorney docket no. 25-0398-US, is hereby incorporated by reference herein.

These, as well as other aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate the invention by way of example only and, as such, that numerous variations are possible.

### BRIEF DESCRIPTION OF THE DRAWINGS

FIG. 1 is a block diagram of a computing device, according to an example.

FIG. 2 is a block diagram of a computing device, a light source, and an optical instrument contained within an environmental chamber, according to an example.

FIG. 3 is a schematic diagram of an optical instrument, an environmental chamber, and a computing device, according to an example.

FIG. 4 is a schematic diagram of an optical instrument contained by an enclosure, according to an example.

FIG. 5 is a schematic diagram of an optical instrument with an enclosure removed, according to an example.

FIG. 6 is a schematic diagram of an exterior of a port of an enclosure, according to an example.

FIG. 7 is a schematic diagram of an enclosure, a selection module, and a transmission light module, according to an example.

FIG. 8 is another schematic diagram of an enclosure, a selection module, and a transmission light module, according to an example.

FIG. 9 is a cross-sectional view of an optical module positioned within an enclosure, according to an example.

FIG. 10 is a schematic diagram of a plate, according to an example.

FIG. 11 is a cross-sectional schematic diagram of a transmission light module, according to an example.

FIG. 12 is a transparent view of a transmission light module, according to an example.

FIG. 13 is a block diagram of a method, according to an example.

### DETAILED DESCRIPTION

As noted above, conventional instruments for imaging live cells have some limitations. For example, various instruments can only incubate small quantities of cells and cannot perform some useful modes of microscopy. Described herein are examples of optical instruments and methods of operation that can help alleviate these issues.

An optical instrument includes an enclosure that includes a window and a port configured to receive a first light via an optical cable. The first light is typically an excitation light in the form of a laser beam. The optical instrument also includes an objective configured to be aligned with the window such that the first light exiting the enclosure through the window enters the objective and a second light from the objective enters the enclosure through the window. During use of the optical instrument, the objective is typically aligned with the sample such that the second light originating from the sample is focused by the objective and passes through the window into the enclosure. The optical instrument includes an optical module positioned within the enclosure. The optical module includes a dichroic mirror that is configured to separate the first light (e.g., the excitation light) from the second light (e.g., the light originating from the sample). The optical module also includes one or more first optical elements (e.g., lenses, mirrors, prisms, filters, or gratings) configured to direct the first light from the port to the dichroic mirror. The optical module also includes one or more second optical elements configured to direct the first light from the dichroic mirror, through the window, and into the objective (e.g., such that the first light is focused onto the sample). The one or more second optical elements are also configured to direct the second light from the window to the dichroic mirror. The optical module also includes a plate (e.g., a disc) having openings patterned for spinning disc confocal microscopy. The plate is configured to be inserted into or removed from an area between the dichroic mirror and the one or more second optical elements, depending on the mode of operation. The optical module also includes an image sensor and one or more third optical elements configured to direct the second light from the dichroic mirror to the image sensor.

As described in more detail below, embodiments of the aforementioned optical instrument are configured to incubate larger quantities of live cells for imaging analysis and configured to perform several modes of microscopy—including spinning disc confocal microscopy. The optical module is generally sealed within an enclosure that isolates the optical module from conditions outside of the enclosure. Thus, the optical module can be placed within a large environmental chamber in close proximity to a large number of incubated biological samples. The enclosed optical module also facilitates several modes of microscopy, such as spinning disc confocal microscopy, which are not feasible when using conventional microscopes and conventional sample containment.

Confocal microscopy reduces out-of-focus light, thereby enabling optical sectioning of three-dimensional biological structures. Spinning disc confocal microscopy enables high acquisition speeds due to parallelization of the openings (e.g., pinholes) within the spinning disc.

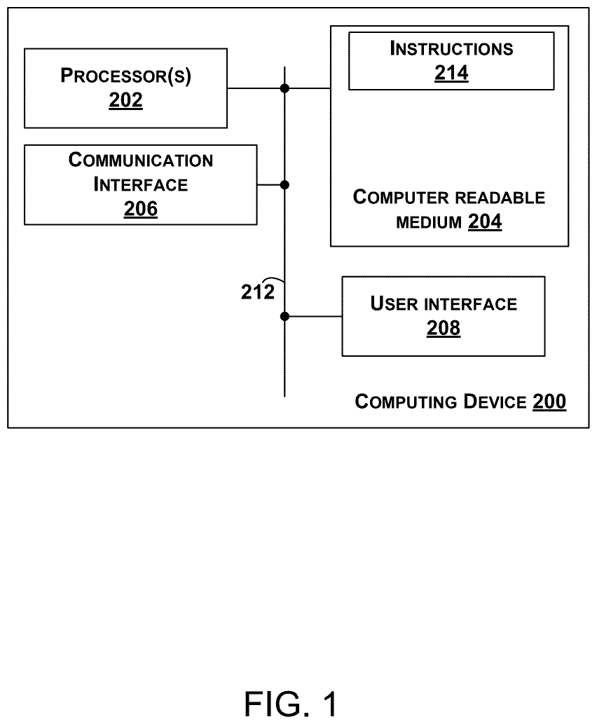

FIG. 1 is a block diagram of a computing device 200. The computing device 200 includes one or more processors 202, a non-transitory computer readable medium 204, a communication interface 206, and a user interface 208. Components of the computing device 200 can be linked together by a system bus, network, or other connection mechanism 212.

The one or more processors 202 can be any type of processor(s), such as a microprocessor, a field programmable gate array, a digital signal processor, a multicore processor, such as a central processing unit (CPU), or a graphics processing unit (GPU), etc., coupled to the non-transitory computer readable medium 204.

The non-transitory computer readable medium 204 can be any type of memory, such as volatile memory like random access memory (RAM), dynamic random access memory (DRAM), static random access memory (SRAM), or non-volatile memory like read-only memory (ROM), flash memory, magnetic or optical disks, or compact-disc read-only memory (CD-ROM), among other devices used to store data or programs on a temporary or permanent basis.

Additionally, the non-transitory computer readable medium 204 may store instructions 214. The instructions 214 can be executable by the one or more processors 202 to cause the computing device 200 to perform any of the functions or methods described herein.

The communication interface 206 includes hardware to enable communication within the computing device 200 and/or between the computing device 200 and one or more other devices. The hardware can include any type of input and/or output interfaces, a universal serial bus (USB), PCI Express, transmitters, receivers, and antennas, for example. The communication interface 206 can be configured to facilitate communication with one or more other devices, in accordance with one or more wired or wireless communication protocols. For example, the communication interface 206 can be configured to facilitate wireless data communication for the computing device 200 according to one or more wireless communication standards, such as one or more Institute of Electrical and Electronics Engineers (IEEE) 801.11 standards, ZigBee standards, Bluetooth standards, etc. As another example, the communication interface 206 can be configured to facilitate wired data communication with one or more other devices. The communication interface 206 may also include analog-to-digital converters (ADCs) or digital-to-analog converters (DACs) that the computing device 200 can use to control various components of the computing device 200 or external devices.

The user interface 208 includes any type of display component configured to display data. As one example, the user interface 208 can include a touchscreen display. As another example, the user interface 208 can include a flat-panel display, such as a liquid-crystal display (LCD) or a light-emitting diode (LED) display. The user interface 208 includes one or more pieces of hardware used to provide data and control signals to the computing device 200. For instance, the user interface 208 can include a mouse or a pointing device, a keyboard or a keypad, a microphone, a touchpad, or a touchscreen, among other possible types of user input devices. Generally, the user interface 208 may enable an operator to interact with a graphical user interface (GUI) provided by the computing device 200 (e.g., displayed by the user interface 208).

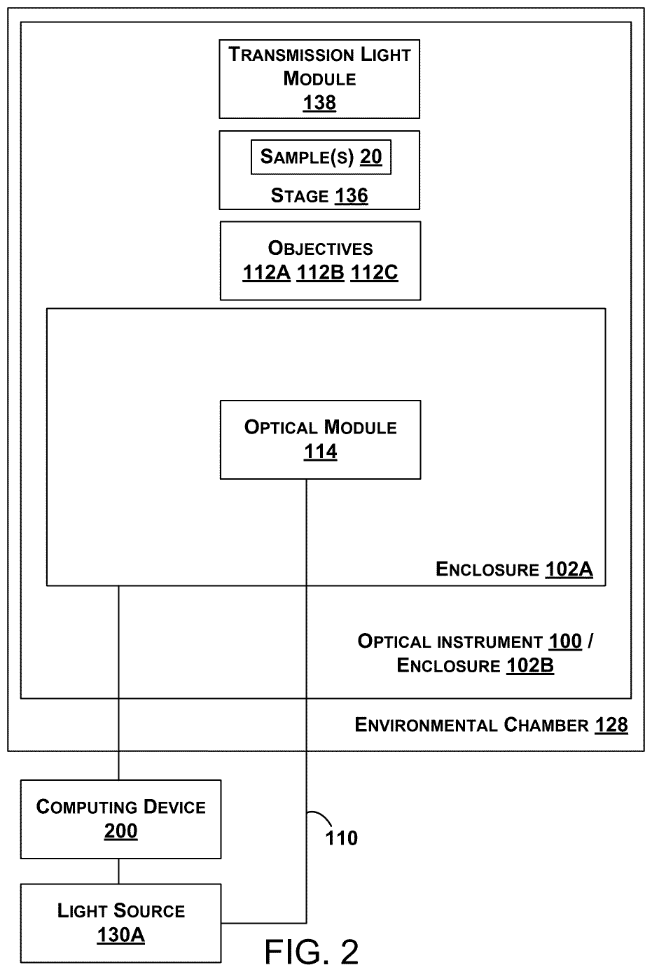

FIG. 2 is a block diagram of the computing device 200, a light source 130A, and an optical instrument 100 contained within an environmental chamber 128. The computing device 200 is configured to control the optical instrument 100 and the light source 130A.

The light source 130A can take the form of one or more lasers, one or more light emitting diodes (LEDs), or one or more halogen or arc lamps. The light source 130A is optically coupled to the optical instrument 100 via an optical cable 110 (e.g., a cable including one or more optical fibers). The light source 130A is typically located outside of the environmental chamber 128.

The environmental chamber 128, which can also be referred to as an incubator, is configured to maintain first environmental conditions within the environmental chamber 128 that are different from second environmental conditions outside of the environmental chamber 128. Such environmental conditions controlled by the environmental chamber 128 can include one or more of temperature, humidity, or partial pressure of carbon dioxide.

The optical instrument 100 includes an enclosure 102A that contains an optical module 114. The optical instrument 100 also includes an objective 112A, an objective 112B, an objective 112C, a stage 136 configured to hold one or more biological samples 20, and a transmission light module 138. The optical instrument 100 could also have fewer objectives or more objectives than what is shown in FIG. 2.

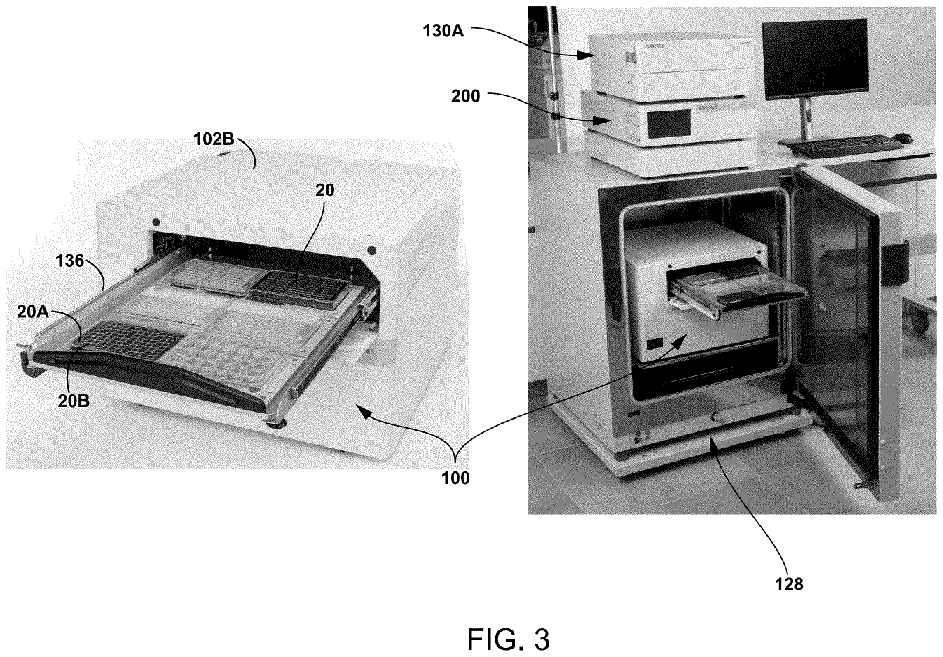

FIG. 3 is a schematic diagram of the optical instrument 100, the environmental chamber 128, and the computing device 200. As shown, the stage 136 can take the form of a retractable drawer and be configured to hold one or more vessels that contain one or more biological samples 20. The optical instrument 100 contained by the enclosure 102B is configured for placement within the environmental chamber 128.

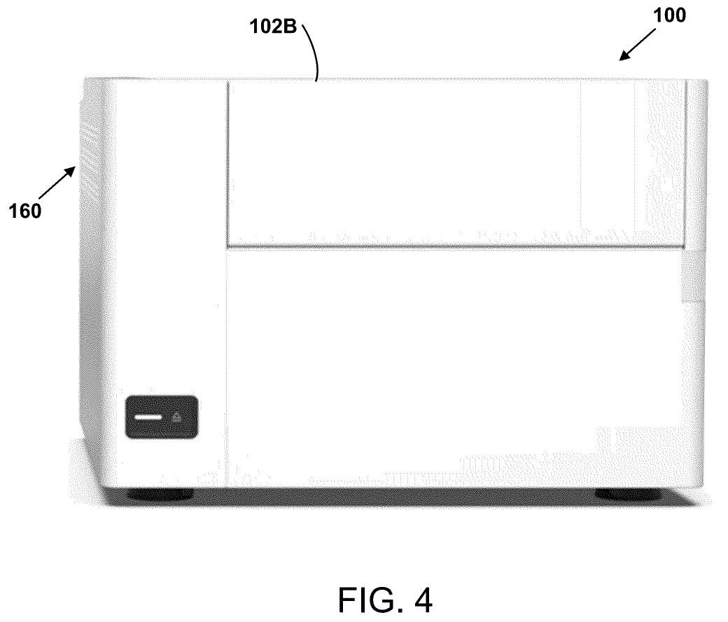

FIG. 4 is a schematic diagram of the optical instrument 100 contained by the enclosure 102B. The enclosure 102B includes a plurality of vents 160 that allow the biological samples 20 within the enclosure 102B to be immersed in the environmental conditions generated by the environmental chamber 128 when the optical instrument 100 and the enclosure 102B are placed within the environmental chamber 128.

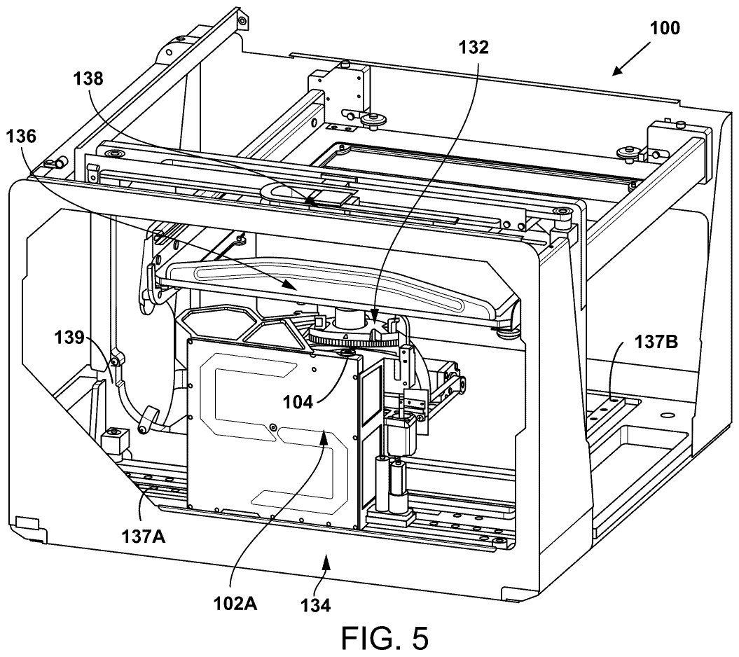

FIG. 5 is a schematic diagram of the optical instrument 100 with the enclosure 102B removed.

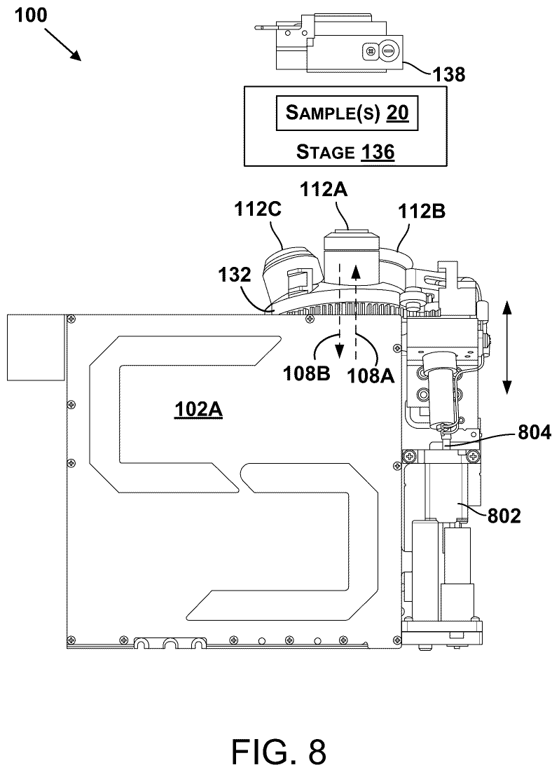

The optical instrument 100 includes the enclosure 102A. The enclosure 102A can be sealed to maintain, within the enclosure 102A, reduced humidity relative to outside of the enclosure 102A. Referring to FIG. 8, the optical module 114 within the enclosure 102A can be at least partially isolated from the environmental conditions maintained by the environmental chamber 128. In some examples, the enclosure 102A is filled with an inert gas (e.g., nitrogen) or dehumidified air. The enclosure 102A also includes a window 104 that is made of glass or plastic, for example. The enclosure 102A can be formed of a material that includes one or more of acetal homopolymer resin, anodized aluminum, or stainless steel. The enclosure 102A can generally be formed of one or more materials that are resistant to swelling in the presence of moisture, non-toxic to cell cultures, resistant to oxidation, resistant to corrosion, and/or resistant to thermal expansion.

The optical instrument 100 also includes a frame 134 configured to support the enclosure 102B. The frame can be formed of metal (e.g., stainless steel angle iron), but other examples are possible. The frame 134 includes a rail 137A and a rail 137B.

The optical module 114 and the enclosure 102A are configured to move with respect to the stage 136 and the frame 134, as controlled by the computing device 200 and one or more motors. For example, the enclosure 102A can move in a direction that coincides with the rail 137A and independently in a direction that coincides with the rail 137B. By moving relative to the stage 136, the optical module 114 can be used to illuminate and capture images of biological samples 20 at different positions on the stage 136 without mechanically disturbing the biological samples 20. The enclosure 102A is slidingly mounted upon the rail 137A that is part of a carriage 139. The carriage 139 and the enclosure 102A can move along the rail 137B as well.

The optical instrument 100 also includes an objective selection module 132 (e.g., a rotatable turret) that is operable such that the objective 112A, the objective 112B, or the objective 112C are selectable for alignment with the window 104.

The optical instrument 100 also includes a transmission light module 138 positioned outside of the enclosure 102A and configured to emit a light beam toward the window 104. During typical operation of the transmission light module 138, a biological sample 20 and the stage 136 will be between the window 104 and the transmission light module 138. The transmission light module 138 is attached to the carriage 139 such that the transmission light module 138 is moved in unison with the enclosure 102A and maintains alignment with the window 104.

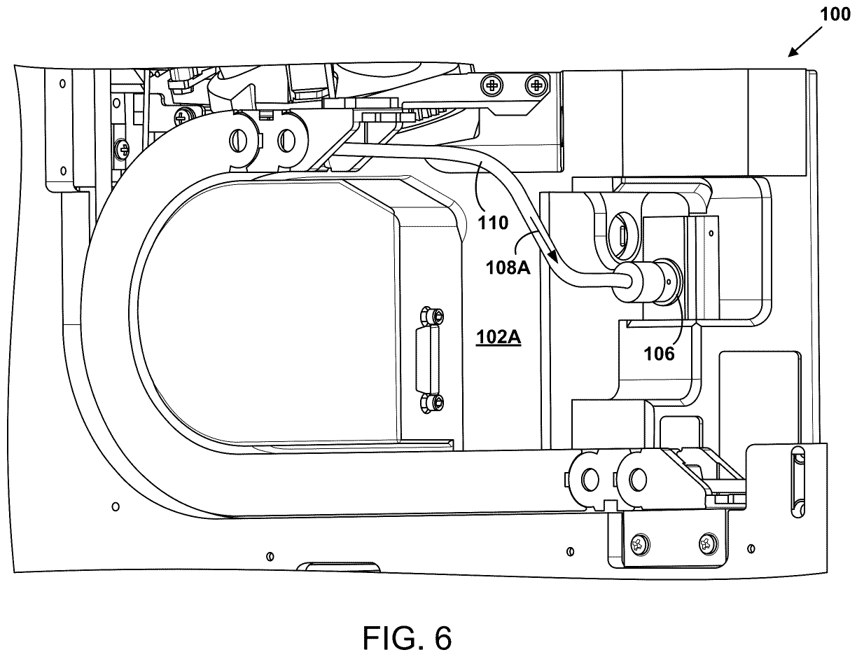

FIG. 6 is a schematic diagram of an exterior of the port 106 of the enclosure 102A. The port 106 is configured to receive a light 108A (e.g., a laser beam) via the optical cable 110. Thus, the port 106 typically takes the form of an optical coupler configured to receive an end of the optical cable 110.

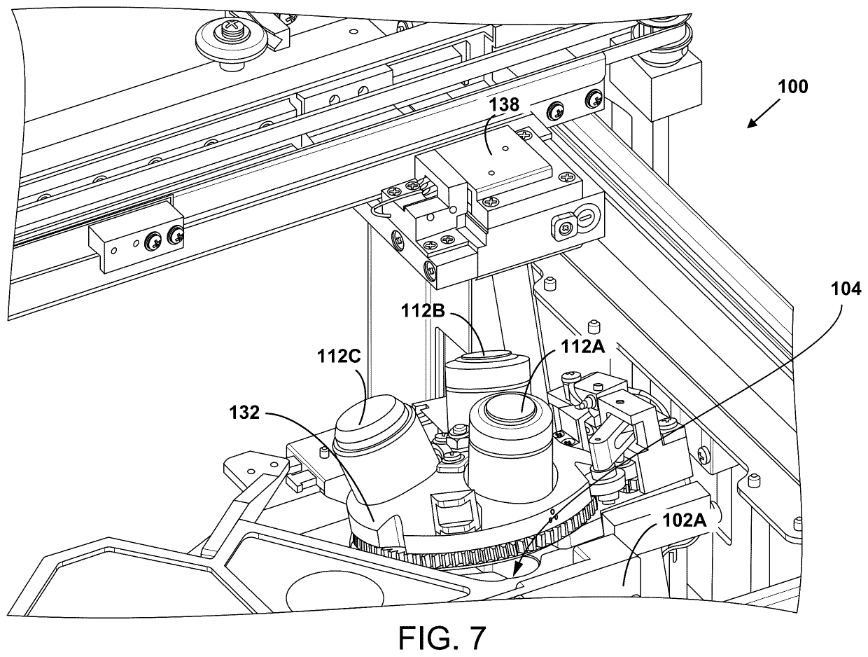

FIG. 7 is a schematic diagram of the enclosure 102A, the objective selection module 132, and the transmission light module 138. The objective selection module 132 is operable (e.g., rotatable) such that the objective 112A, the objective 112B, or the objective 112C are each selectable for alignment with the window 104. For example, when selected and arranged appropriately, the objective 112A is aligned with the window 104 such that light exiting the enclosure 102A through the window 104 enters the objective 112A and light from the objective 112A enters the enclosure 102A through the window 104.

FIG. 8 is another schematic diagram of the enclosure 102A, the objective selection module 132, and the transmission light module 138. During typical operation of the transmission light module 138, the stage 136 and one or more biological samples 20 are between the transmission light module 138 and the objectives 112.

As shown in FIG. 8, the objective 112A is aligned with the window 104 such that the light 108A exiting the enclosure 102A through the window 104 enters the objective 112A and the light 108B from the objective 112B enters the enclosure 102A through the window 104.

The optical instrument 100 adjusts a depth of focus within the biological samples 20 by moving the objective selection module 132 and the objectives 112 up or down with respect to the stage 136. For example, the computing device 200 controls a motor 802 to move a shaft 804 up or down, thereby moving the objective selection module 132 and the objective 112 up or down. The shaft 804 is mechanically coupled to the objective selection module 132.

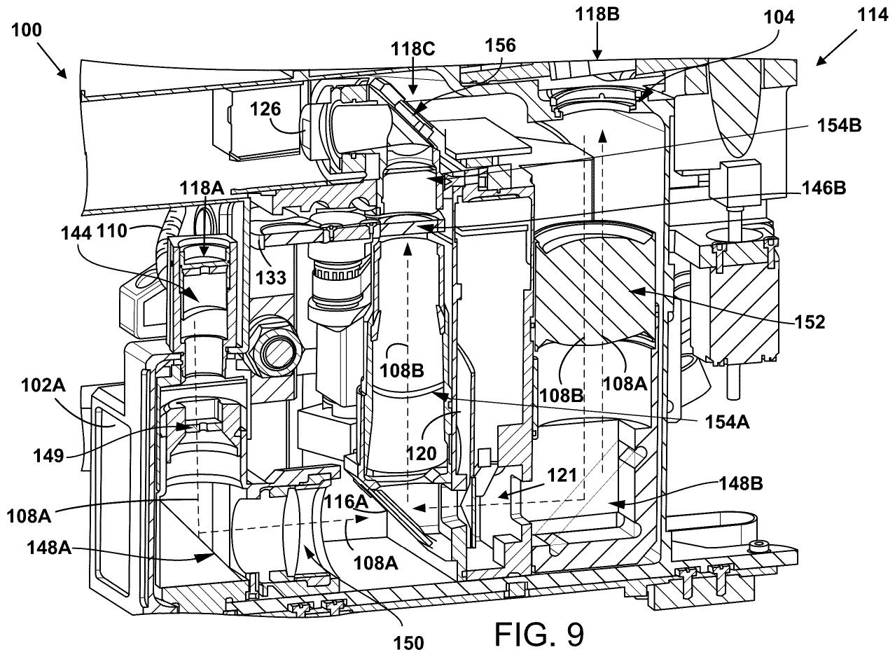

FIG. 9 is a cross-sectional view of the optical module 114 positioned within the enclosure 102A. The optical module 114 includes a dichroic mirror 116A, first optical elements 118A, second optical elements 118B, a plate 120, an image sensor 126, and third optical elements 118C.

The dichroic mirror 116A can take the form of an interference filter that is configured to reflect light having certain wavelengths and transmit light having other wavelengths. In the particular example shown in FIG. 9, the dichroic mirror 116A is configured to transmit the light 108A that is received via the port 106 from the optical cable 110 and configured to reflect the light 108B that is received from the objective 112A. The port 106 is shown in FIG. 6. The dichroic mirror 116A is interchangeable with other dichroic mirrors having different wavelength-dependent transmission or reflection characteristics.

The first optical elements 118A are configured to direct the light 108A from the port 106 to the dichroic mirror 116A. The first optical elements 118A include a parabolic mirror 144 configured to direct the light 108A received from the port 106 toward the dichroic mirror 116A via a rectangular micro lens array 149. The first optical elements 118A further include the rectangular micro lens array 149 configured to shape the light 108A received from the parabolic mirror 144. The optical elements further include a prism mirror 148A configured to reflect the light 108A received from the rectangular micro lens array 149 toward the dichroic mirror 116A. The first optical elements 118A further include a positive lens 150 configured to shape the light 108A received from the prism mirror 148A toward the dichroic mirror 116A. The dichroic mirror 116A is configured to transmit the light 108A from the positive lens 150 toward an area 121. The area 121 might or might not be occupied by the plate 120.

The second optical elements 118B are configured to direct the light 108A from the dichroic mirror 116A, through the window 104, and into the objective 112A and configured to direct the light 108B from the window 104 to the dichroic mirror 116A. The second optical elements 118B include a prism mirror 148B configured to reflect the light 108A from the dichroic mirror 116A toward the window 104 and reflect the light 108B toward the dichroic mirror 116A. The second optical elements 118B further include a tube lens 152 configured to shape the light 108A from the prism mirror 148B and transmit the light 108A through the window 104 to the objective 112A. The tube lens 152 and the objective 112A are configured to focus the light 108A onto a biological sample 20 held by the stage 136. The tube lens 152 is also configured to shape the light 108B from the objective 112A and transmit the light 108B to the prism mirror 148B.

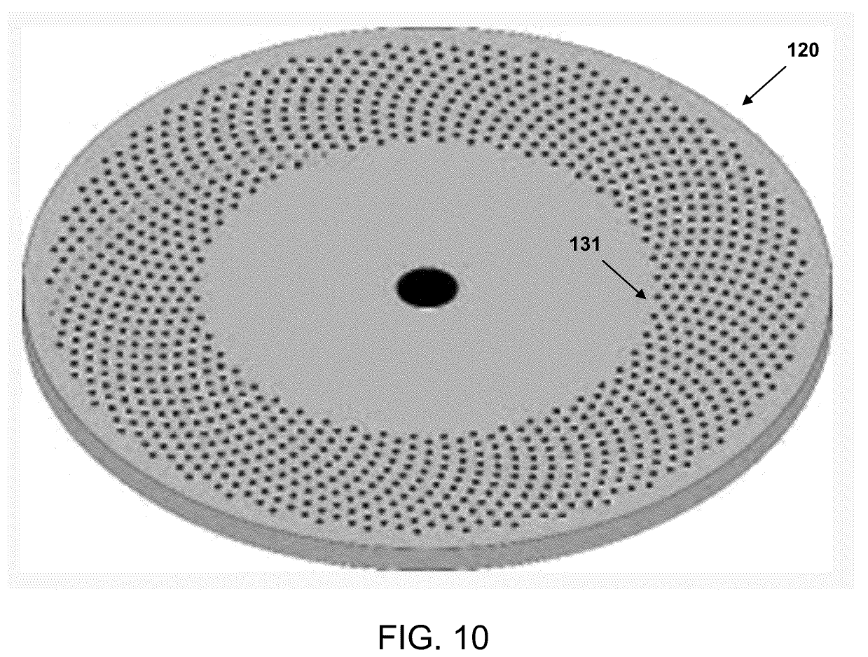

Referring to FIG. 10, the plate 120 has openings 131 patterned for spinning disc confocal microscopy. The plate 120 can take the form of a glass disc that is patterned with paint or metal to reveal the openings 131. The openings 131 can take the form of pinholes arranged in one or more Archimedean spirals, or any other pinhole or slit arrangement within the area 121 that allows for scanning the imaged area optically conjugate to the image sensor 126. The openings 131 are configured to spatially filter the light 108A and the light 108B when the plate 120 is rotating within the area 121.

Referring to FIG. 9, the plate 120 is configured to be inserted into or removed from the area 121 between the dichroic mirror 116A and the second optical elements 118B. The area 121 includes a conjugate focal plane with respect to the image sensor 126. The optical instrument 100 generally operates in a confocal mode when the plate 120 is positioned within the area 121 and operates in a widefield mode when the plate 120 is not positioned within the area 121.

The image sensor 126 can take the form of a complementary metal oxide semiconductor (CMOS) image sensor, but other examples are possible, such as a charge coupled device (CCD), scientific CMOS (sCMOS) image sensor, or an electron multiplying charge-coupled device (EMCCD).

The third optical elements 118C are configured to direct the light 108B from the dichroic mirror 116A to the image sensor 126. The third optical elements 118C include relay lenses 154A configured to receive the light 108B from the dichroic mirror 116A. The relay lenses 154A are configured to infinitely focus the light 108B. The third optical elements 118C also include another mirror 156 configured to direct the light 108B from the relay lenses 154B to the image sensor 126. The relay lenses 154B are configured to convergently focus the light 108B.

The optical instrument 100 also includes multiple optical filters 146B disposed within a filter selection module 133. The filter selection module 133 is operable (e.g., rotatable) to place a particular optical filter 146B (or no optical filter) between the relay lenses 154A and the relay lenses 154B. Each of the optical filters 146B can have different wavelength-dependent transmission characteristics. Via the filter selection module 133, the optical instrument 100 is configured to insert one or more optical filters 146B between the relay lenses 154A and the relay lenses 154B and configured to remove the one or more optical filters 146B from between the relay lenses 154A and the relay lenses 154B. Typically, at least some of the optical filters 146B are configured to reduce the transmission of the light 108A that strays into the third optical elements 118C.

The first optical elements 118A, specifically the parabolic mirror 144 and the rectangular micro lens array 149, define a first optical axis along which the light 108A travels. The second optical elements 118B define a second optical axis along which the light 108A and the light 108B travel. The third optical elements 118C define a third optical axis along which primarily the light 108B travels. The first optical axis, the second optical axis, and the third optical axis are parallel to each other as shown in FIG. 9.

The optical instrument 100 is configured to operate in a widefield fluorescence mode, a confocal fluorescence mode, a bright field mode, a reflection mode, and a phase contrast mode.

In the widefield fluorescence mode, the biological sample 20 is illuminated by the light 108A to induce fluorescence from the biological sample 20 in the form of the light 108B. The plate 120 is removed from the area 121 such that images captured by the image sensor 126 are widefield images that are not spatially filtered.

In the confocal fluorescence mode, the biological sample 20 is illuminated by the light 108A to induce fluorescence from the biological sample 20 in the form of the light 108B. The plate 120 is inserted into the area 121 such that images captured by the image sensor 126 are confocal images that are spatially filtered.

In the bright field mode, the biological sample 20 is illuminated by the transmission light module 138. The light 108B represents light that transmits through the biological sample 20 or passes around the biological sample 20. The plate 120 is removed from the area 121 such that images captured by the image sensor 126 are widefield images that are not spatially filtered. Alternatively, the plate 120 is rotated within the area 121 such that images captured by the image sensor 126 are confocal images that are spatially filtered.

In the dark field mode, the transmission light module 138 (see FIG. 8) uses an annulus that prevents almost any light from being transmitted from the transmission light module 138 to the objective 112A through the window 104 and to the image sensor 126. If a biological sample 20 is present between the transmission light module 138 and the objective 112A, the biological sample 20 refracts or scatters the light so that part of that light is then redirected towards the objective 112A and to the image sensor 126.

In the reflection mode, the biological sample 20 is illuminated by the light 108A to induce reflection from the biological sample 20 in the form of the light 108B. The plate 120 is removed from the area 121 such that images captured by the image sensor 126 are widefield images that are not spatially filtered. Alternatively, the plate 120 is rotated within the area 121 such that images captured by the image sensor 126 are confocal images that are spatially filtered.

The phase contrast mode is implemented at least partially through computational means. The optical instrument 100 operating in the phase contrast mode generally involves using an annulus in the transmission light module 138 and including a phase plate as part of the third optical elements 118C and/or the objective(s) 112.

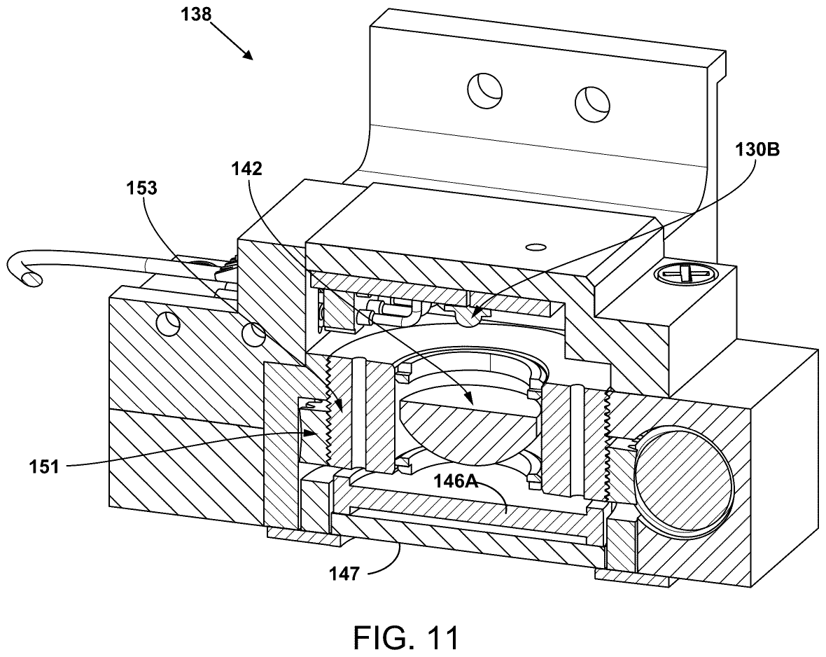

FIG. 11 is a cross-sectional schematic diagram of the transmission light module 138. The transmission light module 138 includes a light source 130B such as one or more LEDs and a collection lens 142 positioned between the window 104 and the light source 130B. The transmission light module 138 further includes a fine grit diffuser 147 positioned between the window 104 and the collection lens 142. The transmission light module 138 further includes a filter 146A positioned between the window 104 and the collection lens 142. A distance between the light source 130B and the collection lens 142 is adjustable via a worm gear 151 and a threaded lens adapter 153.

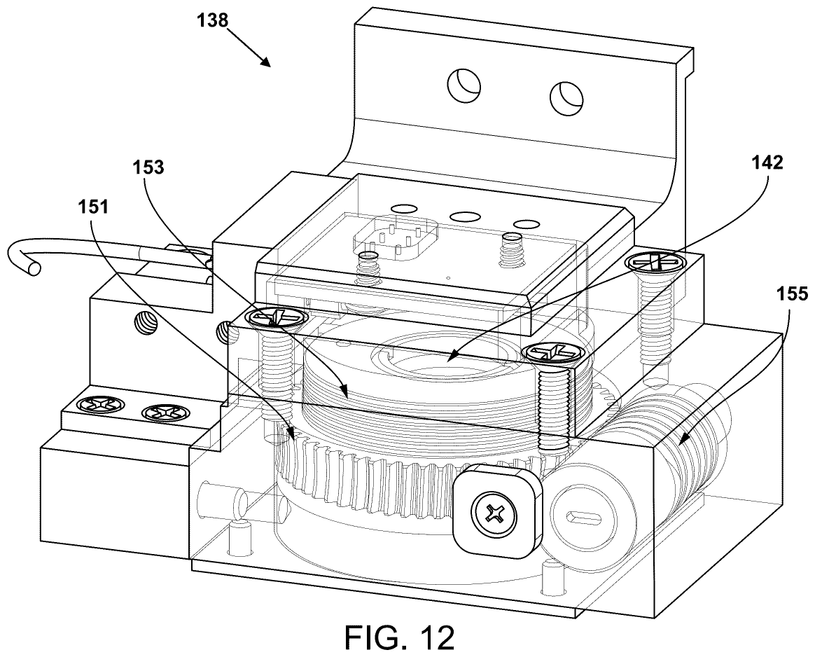

FIG. 12 is a transparent view of the transmission light module 138. The worm shaft 155 is turned (e.g., via a screwdriver) to turn the worm gear 151, which causes the threaded lens adapter 153 to move the collection lens 142 up or down.

Referring to various aforementioned figures, methods of operating the optical instrument 100 are described below. For example, the optical instrument 100 moves the optical module 114 that is within the enclosure 102A relative to the stage 136 that supports a biological sample 20A (e.g., living cells) and a biological sample 20B (e.g., living cells), thereby aligning the optical module 114 with the biological sample 20A. While aligned with the biological sample 20A, the optical module 114 captures one or more first images of the biological sample 20A. Next, the optical instrument 100 moves the optical module 114 relative to the stage 136 again, thereby aligning the optical module 114 with the biological sample 20B. While aligned with the biological sample 20B, the optical module 114 captures one or more second images of the biological sample 20B.

FIG. 3 shows the biological sample 20A contained by a first vessel and the biological sample 20B contained by an adjacent second vessel. Other examples are possible. The biological sample 20A and the biological sample 20B could share some of the same biological material while having at least some biological material that is not in common. In many contexts, the delineation between the biological sample 20A and the biological sample 20B can correspond with different fields of view captured by the image sensor 126.

In various examples, the one or more first images and/or the one or more second images can be captured in the widefield fluorescence mode, the confocal fluorescence mode, the bright field mode, the reflection mode, or the phase contrast mode.

In the widefield mode, capturing the one or more first images can be performed while the plate 120 is removed from an optical path of the optical instrument 100, that is, removed from the area 121 shown in FIG. 9. In the widefield mode, capturing the one or more first images can be performed while illuminating the biological sample 20A with the optical module 114.

In some examples, the transmission light module 138 shown in FIG. 8 is used to illuminate biological samples 20. Accordingly, the optical instrument 100 moves the transmission light module 138 (e.g., in parallel with the optical module 114) such that the biological sample 20A is between the transmission light module 138 and the optical module 114. In this context, capturing the one or more first images is done while illuminating the biological sample 20A with the transmission light module 138. Furthermore, the plate 120 can be rotating within the area 121, making the one or more first images confocal images that are focused at varying depths of the biological sample 20A.

In some examples, different excitation wavelengths can be used. Accordingly, the optical module 114 can illuminate the biological sample 20A with a first monochromatic light having a first wavelength, and thereafter illuminate the biological sample 20A with a second monochromatic light having a second wavelength. In this context, capturing the one or more first images is performed while illuminating the biological sample 20A with the first monochromatic light. The optical module 114 also captures another image while illuminating the biological sample 20A with the second monochromatic light.

In the widefield mode, capturing the one or more second images can be performed while the plate 120 is removed from an optical path of the optical instrument 100, that is, removed from the area 121 shown in FIG. 9. In the widefield mode, capturing the one or more second images can be performed while illuminating the biological sample 20B with the optical module 114.

In some examples, the transmission light module 138 shown in FIG. 8 is used to illuminate biological samples 20. Accordingly, the optical instrument 100 moves the transmission light module 138 (e.g., in parallel with the optical module 114) such that the biological sample 20B is between the transmission light module 138 and the optical module 114. In this context, capturing the one or more second images is done while illuminating the biological sample 20B with the transmission light module 138. Furthermore, the plate 120 can be rotating within the area 121, making the one or more second images confocal images that are focused at varying depths of the biological sample 20B.

In some examples, different excitation wavelengths can be used. Accordingly, the optical module 114 can illuminate the biological sample 20B with a first monochromatic light having a first wavelength, and thereafter illuminate the biological sample 20B with a second monochromatic light having a second wavelength. In this context, capturing the one or more second images is performed while illuminating the biological sample 20B with the first monochromatic light. The optical module 114 also captures another image while illuminating the biological sample 20B with the second monochromatic light.

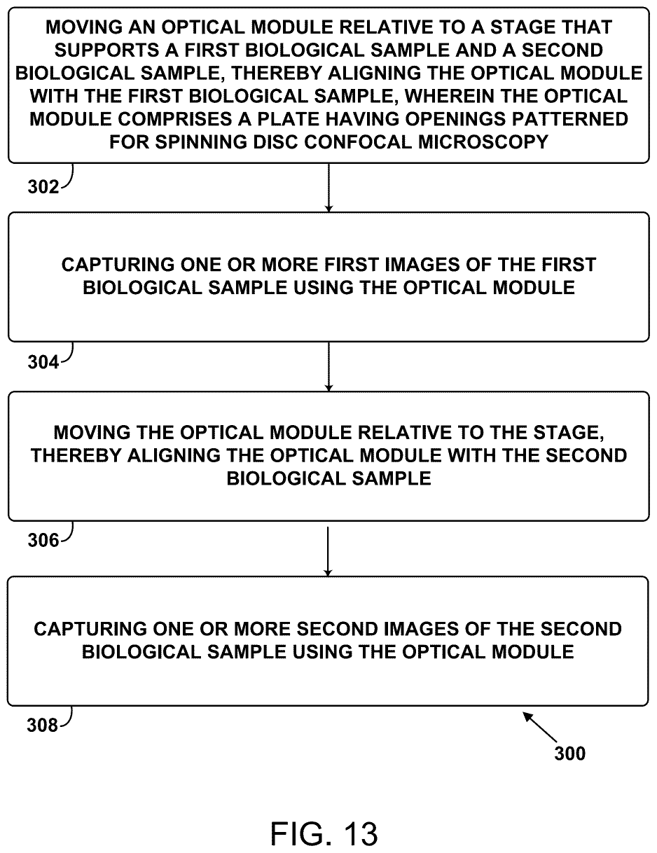

FIG. 13 is a block diagram of a method 300 for operating the optical instrument 100. As shown in FIG. 13, the method 300 includes one or more operations, functions, or actions as illustrated by blocks 302, 304, 306, and 308. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 302, the method 300 includes the optical instrument 100 moving the optical module 114 relative to the stage 136 that supports the biological sample 20A and the biological sample 20B, thereby aligning the optical module 114 with the biological sample 20A. The optical module 114 includes the plate 120 having the openings 131 patterned for spinning disc confocal microscopy. Functionality related to block 302 is discussed above with reference to FIGS. 1-12.

At block 304, the method 300 includes capturing the one or more first images of the biological sample 20A using the optical module. Functionality related to block 304 is discussed above with reference to FIGS. 1-12.

At block 306, the method 300 includes the optical instrument 100 moving the optical module 114 relative to the stage 136, thereby aligning the optical module 114 with the biological sample 20B. Functionality related to block 306 is discussed above with reference to FIGS. 1-12.

At block 308, the method 300 includes capturing the one or more second images of the biological sample 20B using the optical module 114. Functionality related to block 308 is discussed above with reference to FIGS. 1-12.

While various example aspects and example embodiments have been disclosed herein, other aspects and embodiments will be apparent to those skilled in the art. The various example aspects and example embodiments disclosed herein are for purposes of illustration and are not intended to be limiting, with the true scope and spirit being indicated by the following claims.

1. An optical instrument comprising:
an enclosure comprising:
a window; and
a port configured to receive a first light via an optical cable;
an objective configured to be aligned with the window such that the first light exiting the enclosure through the window enters the objective and a second light from the objective enters the enclosure through the window; and
an optical module positioned within the enclosure, the optical module comprising:
a dichroic mirror;
one or more first optical elements configured to direct the first light from the port to the dichroic mirror;
one or more second optical elements configured to direct the first light from the dichroic mirror, through the window, and into the objective and configured to direct the second light from the window to the dichroic mirror;
a plate having openings patterned for spinning disc confocal microscopy, wherein the plate is configured to be inserted into or removed from an area between the dichroic mirror and the one or more second optical elements;
an image sensor; and
one or more third optical elements configured to direct the second light from the dichroic mirror to the image sensor.

2. The optical instrument of claim 1, wherein the enclosure is sealed.

3. (canceled)

4. The optical instrument of claim 1, wherein the optical instrument is configured for placement in an environmental chamber that is configured to maintain a first temperature within the environmental chamber that is different from a second temperature outside of the environmental chamber, maintain a first humidity within the environmental chamber that is different from a second humidity outside of the environmental chamber, or maintain a first partial pressure of carbon dioxide within the environmental chamber that is different from a second partial pressure of carbon dioxide outside of the environmental chamber.

5-6. (canceled)

7. The optical instrument of claim 1, further comprising:
an environmental chamber; and
a light source positioned outside of the environmental chamber, wherein the light source is configured to provide the first light to the enclosure via the optical cable.

8-9. (canceled)

10. The optical instrument of claim 1, wherein the optical instrument is configured to operate in at least one of a widefield fluorescence mode, a confocal fluorescence mode, a bright field mode, a dark field mode, a reflection mode, or a phase contrast mode.

11. (canceled)

12. The optical instrument of claim 1, wherein the enclosure is formed of one or more materials that are one or more of resistant to swelling in the presence of moisture, non-toxic to cell cultures, resistant to oxidation, resistant to corrosion, or resistant to thermal expansion.

13-15. (canceled)

16. The optical instrument of claim 1, further comprising:
a frame; and
a stage that is mounted to the frame and configured to hold one or more biological samples,
wherein the optical module and the enclosure are configured to move with respect to the stage.

17. (canceled)

18. The optical instrument of claim 16, further comprising:
a transmission light module positioned outside of the enclosure and configured to emit a light beam toward the window, wherein
the stage is positioned between the transmission light module and the objective.

19-24. (canceled)

25. The optical instrument of claim 1, wherein the enclosure that comprises the window and the port is a primary enclosure, wherein the primary enclosure is configured to maintain, within the primary enclosure, reduced humidity relative to outside of the primary enclosure.

26-29. (canceled)

30. The optical instrument of claim 1. wherein the one or more first optical elements comprise a parabolic mirror configured to direct the first light received from the port toward the dichroic mirror.

31. The optical instrument of claim 30, wherein the one or more first optical elements further comprise a rectangular micro lens array configured to shape the first light received from the parabolic mirror.

32. The optical instrument of claim 31, wherein the one or more first optical elements further comprise a prism mirror configured to reflect the first light received from the rectangular micro lens array.

33. The optical instrument of claim 32, wherein the one or more first optical elements further comprise a positive lens configured to shape the first light received from the prism mirror toward the dichroic mirror.

34. The optical instrument of claim 33, wherein the dichroic mirror is configured to transmit the first light from the positive lens.

35. The optical instrument of claim 1. wherein the one or more second optical elements comprise a prism mirror configured to reflect the first light from the dichroic mirror toward the window and reflect the second light toward the dichroic mirror.

36. The optical instrument of claim 35, wherein the one or more second optical elements further comprise a tube lens configured to shape the first light from the prism mirror and transmit the first light through the window to the objective.

37. The optical instrument of claim 36, wherein the tube lens and the objective are configured to focus the first light onto a sample.

38. The optical instrument of claim 36. wherein the tube lens is configured to shape the second light from the objective and transmit the second light to the prism mirror.

39. The optical instrument of claim 1. wherein the one or more third optical elements comprise one or more first relay lenses configured to receive the second light from the dichroic mirror.

40. The optical instrument of claim 39, wherein the one or more first relay lenses are configured to infinitely focus the second light.

41. The optical instrument of claim 40, wherein the one or more third optical elements further comprise:
one or more second relay lenses; and
one or more optical filters each having different wavelength-dependent transmission characteristics, wherein the optical instrument is configured to insert one or more optical filters between the one or more first relay lenses and the one or more second relay lenses and configured to remove the one or more optical filters from between the one or more first relay lenses and the one or more second relay lenses.

42. (canceled)

43. The optical instrument of claim 41, wherein the one or more third optical elements comprise another mirror configured to direct the second light from the one or more second relay lenses to the image sensor.

44. (canceled)

45. The optical instrument of claim 1. wherein the one or more first optical elements define a first optical axis, wherein the one or more second optical elements define a second optical axis, wherein the one or more third optical elements define a third optical axis, wherein the first optical axis, the second optical axis, and the third optical axis are parallel to each other.

46. A method of operating an optical instrument, the method comprising:
moving an optical module relative to a stage that supports a first biological sample and a second biological sample, thereby aligning the optical module with the first biological sample, wherein the optical module comprises a plate having openings patterned for spinning disc confocal microscopy;
capturing one or more first images of the first biological sample using the optical module;
moving the optical module relative to the stage, thereby aligning the optical module with the second biological sample; and
capturing one or more second images of the second biological sample using the optical module.

47. The method of claim 46, wherein capturing the one or more first images comprises capturing the one or more first images in a widefield fluorescence mode, a confocal fluorescence mode, a bright field mode, a dark field mode, a reflection mode, or a phase contrast mode.

48. (canceled)

49. The method of claim 47, wherein capturing the one or more first images in the widefield fluorescence mode comprises capturing the one or more first images while illuminating the first biological sample with the optical module.

50. The method of claim 46. further comprising:
moving a transmission light module such that the first biological sample is between the transmission light module and the optical module,
wherein capturing the one or more first images comprises capturing the one or more first images while illuminating the first biological sample with the transmission light module.

51-52. (canceled)

53. The method of claim 46, further comprising:
illuminating the first biological sample with a first monochromatic light having a first wavelength; and thereafter
illuminating the first biological sample with a second monochromatic light having a second wavelength, wherein
capturing the one or more first images comprises capturing an image while illuminating the first biological sample with the first monochromatic light and capturing another image while illuminating the first biological sample with the second monochromatic light.

54. The method of claim 46, wherein capturing the one or more second images comprises capturing the one or more second images in a widefield fluorescence mode, a confocal fluorescence mode, a bright field mode, a dark field mode, a reflection mode, or a phase contrast mode.

55. (canceled)

56. The method of claim 54, wherein capturing the one or more second images in the widefield fluorescence mode comprises capturing the one or more second images while illuminating the second biological sample with the optical module.

57. The method of claim 46, further comprising:
moving a transmission light module such that the second biological sample is between the transmission light module and the optical module,
wherein capturing the one or more second images comprises capturing the one or more second images while illuminating the second biological sample with the transmission light module.

58-59. (canceled)

60. The method of claim 46, further comprising:
illuminating the second biological sample with a first monochromatic light having a first wavelength; and thereafter
illuminating the second biological sample with a second monochromatic light having a second wavelength, wherein
capturing the one or more second images comprises capturing an image while illuminating the second biological sample with the first monochromatic light and capturing another image while illuminating the second biological sample with the second monochromatic light.

61-63. (canceled)

64. A non-transitory computer readable medium storing instructions that, when executed by a computing device operably coupled to an optical instrument, cause the optical instrument to perform functions comprising:
moving an optical module relative to a stage that supports a first biological sample and a second biological sample, thereby aligning the optical module with the first biological sample, wherein the optical module comprises a plate having openings patterned for spinning disc confocal microscopy;
capturing one or more first images of the first biological sample using the optical module;
moving the optical module relative to the stage, thereby aligning the optical module with the second biological sample; and
capturing one or more second images of the second biological sample using the optical module.
